(19) United States
(12) Patent Application Publication
(10) Pub. No.: US 2007/0254618 A1
(43) Pub. Date: Nov. 1, 2007

(54) Methods and apparatus for managing wireless networks using a hierarchical tree structure

(75) Inventor: Mahender Vangati, San Jose, CA (US)

Correspondence Address: INGRASSIA FISHER & LORENZ, P.C., 7150 E. CAMELBACK, STE. 325, SCOTTSDALE, AZ, 85251, US

(73) Assignee: Symbol Technologies, Inc.

(21) Appl. No.: 11/495,290

(22) Filed: Jul. 27, 2006

Related U.S. Application Data
(60) Provisional application No. 60/796,753, filed on May 1, 2006.

(51) Int. Cl. H04B 1/16

(52) U.S. Cl. 455/338

(57) ABSTRACT

A WLAN system enables network modeling and management through an easy-to-navigate tree hierarchy structure. A method for visually representing components at multiple sites within a wireless local area network (WLAN) includes providing a console coupled to the WLAN; organizing, through the console, the components in the multiple sites in a hierarchical tree structure, wherein the tree structure includes a root node, a plurality of site nodes for which the root node is a parent node, and at least one leaf node associated with one of the root nodes, wherein the at least one leaf node corresponds to one of the components; and displaying, via the console, hierarchical tree structure of the components.

### CROSS-REFERENCE TO RELATED APPLICATIONS

This application claims priority from U.S. Provisional Patent Application No. 60/796,753, filed May 1, 2006, which is hereby incorporated by reference.

### TECHNICAL FIELD

The present invention generally relates to wireless local area networks (WLANs) and, more particularly, an improved method of managing WLANs in, for example, retail settings.

### BACKGROUND

There has been a dramatic increase in demand for mobile connectivity solutions utilizing various wireless components and wireless local area networks (WLANs). This generally involves the use of wireless access points that communicate with mobile devices using one or more RF channels (e.g., in accordance with one or more of the IEEE 802.11 standards).

The number of mobile units and associated access ports can be very large in an enterprise. Furthermore, an enterprise may include a number of geographically-dispersed sites, with each site having multiple wireless devices of varying types. As the number of components increases, the management and configuration of those components becomes complicated and time-consuming. Previous solutions generally list devices by name or model in a flat organization structure, a scheme that is not particularly useful for an administrator.

Accordingly, it is desirable to provide improved methods of managing large networks of wireless devices across multiple sites. Other desirable features and characteristics of the present invention will become apparent from the subsequent detailed description and the appended claims, taken in conjunction with the accompanying drawings and the foregoing technical field and background.

### BRIEF SUMMARY OF THE INVENTION

A WLAN system enables network modeling and management through an easy-to-navigate tree hierarchy structure. In one embodiment, a method for visually representing components at multiple sites within a wireless local area network (WLAN) includes: providing a console coupled to the WLAN; organizing, through the console, the components in the multiple sites in a hierarchical tree structure, wherein the tree structure includes a root node, a plurality of site nodes for which the root node is a parent node, and at least one leaf node associated with one of the root nodes, wherein the at least one leaf node corresponds to one of the components; and displaying, via the console, hierarchical tree structure of the components.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 depicts an exemplary WLAN architecture useful in describing the present invention;

FIG. 2 depicts a typical prior art flat site organization;

FIG. 3 depicts a hierarchical tree structure in accordance with one embodiment of the invention; and

FIG. 4 depicts a hierarchical tree structure in accordance with another embodiment of the invention.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., radio-frequency (RF) devices, memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of data transmission protocols and that the system described herein is merely one exemplary application for the invention.

For the sake of brevity, conventional techniques related to signal processing, data transmission, signaling, network control, the 802.11 family of specifications, and other functional aspects of WLAN systems (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

Without loss of generality, in the illustrated embodiment, many of the functions usually provided by a traditional access point (e.g., network management, wireless configuration, and the like) are concentrated in a corresponding wireless switch. It will be appreciated that the present invention is not so limited, and that the methods and systems described herein may be used in conjunction with traditional access points or any other device that communicates via multiple RF channels.

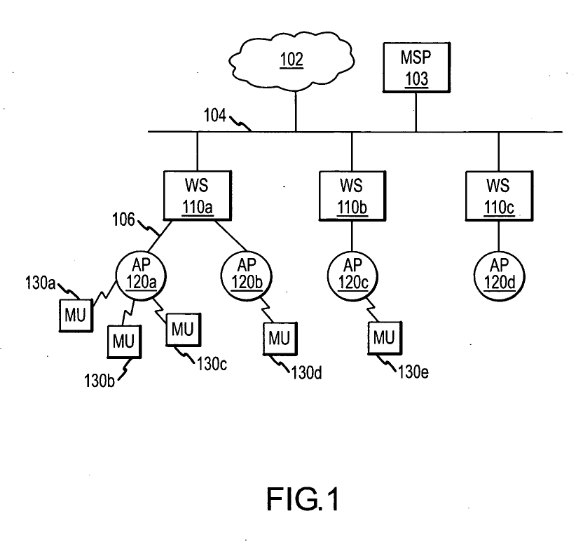

Referring to FIG. 1, which depicts the architecture of an example site, one or more switching devices 110 (alternatively referred to as “wireless switches,” “WS,” or simply “switches”) are coupled to a network 104 (e.g., an Ethernet network coupled to one or more other networks or devices, indicated by network cloud 102). One or more wireless access ports 120 (alternatively referred to as “access ports” or “APs”) are configured to wirelessly connect to one or more mobile units 130 (or “MUs”). APs 120 are suitably connected to corresponding switches 110 via communication lines 106 (e.g., conventional Ethernet lines). Any number of additional and/or intervening switches, routers, servers and other network components may also be present in the system.

A server and/or console system 103 (generally referred to as a “Mobile Services Platform” or simply “MSP”) communicates with the various WLAN components via network 104. As described below, MSP 103 assists with, among other things, monitoring and modeling the WLAN components using a hierarchical organizational scheme. In this regard, MSP 103 may include any suitable combination of hardware, software, displays, CPU's, consoles, servers, databases, and the like. The term “console” as used herein refers to any console (e.g., user interface, computer, etc.) associated with MSP 103.

A particular AP 120 may have a number of associated MUs 130. For example, in the illustrated topology, MUs 130(a), 130(b), and 130(c) are associated with AP 120(a), while MU 130(e) is associated with AP 120(c). Furthermore, one or more APs 120 may be connected to a single switch 110. Thus, as illustrated, AP 120(a) and AP 120(b) are connected to WS 110(a), and AP 120(c) is connected to WS 110(b).

Each WS 110 determines the destination of packets it receives over network 104 and routes that packet to the appropriate AP 120 if the destination is an MU 130 with which the AP is associated. Each WS 110 therefore maintains a routing list of MUs 130 and their associated APs 130. These lists are generated using a suitable packet handling process as is known in the art. Thus, each AP 120 acts primarily as a conduit, sending/receiving RF transmissions via MUs 130, and sending/receiving packets via a network protocol with WS 110.

In accordance with the present invention, the console of MSP 103 enables modeling and management of a site (and the various APs, MUs, and WSs of a site) through an easy-to-navigate tree hierarchy structure. A console associated with MSP 103 displays multiple views, wherein the trees are enhanced to include sites in the hierarchy. MSP 103 allows uploading of the list of sites into an associated server and automatic organization of the sites in a hierarchical fashion, such that management of these sites becomes more meaningful as compared to “flat” organizations.

A “site” as used herein refers to any store, warehouse, or other location that contains a set of network and mobile devices. Thus, the term “site” is not meant to limit the range of possible applications. Furthermore, the network topology and components shown in FIG. 1 are not meant to limit the range of components and architectures with which the present invention may be employed. The methods and systems of the present invention may be used in conjunction with any suitable WLAN structure.

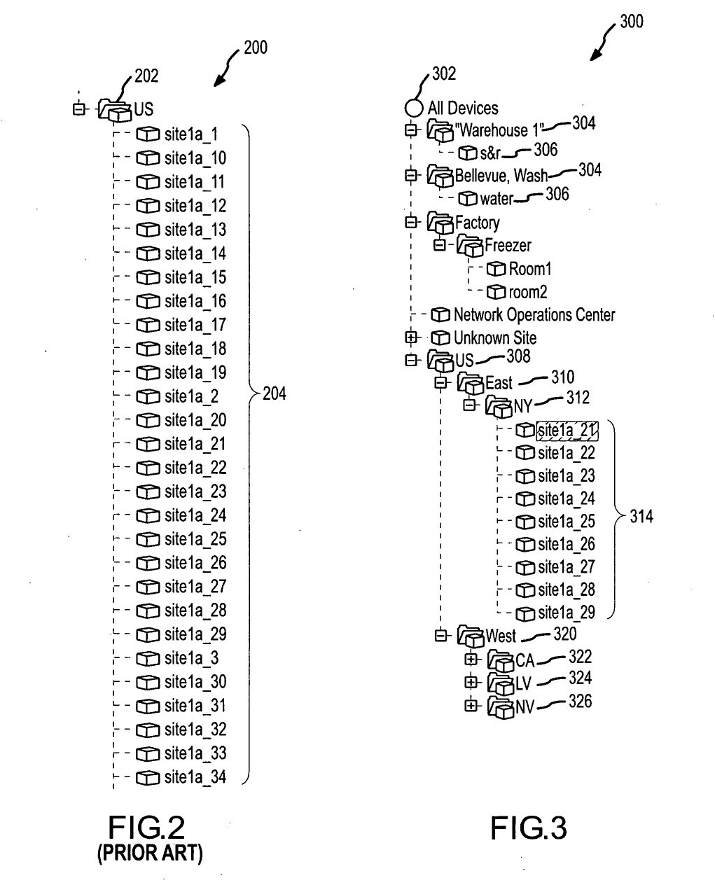

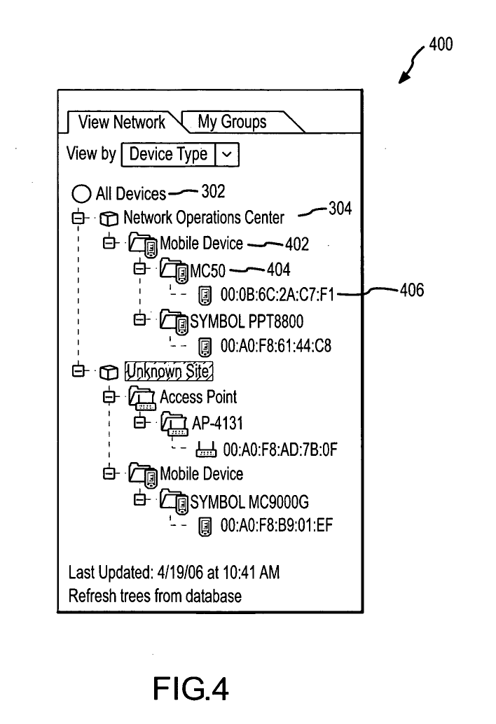

In one embodiment, the sites are organized based on the geographical notations, based on IP address notations, or any other notation meaningful to the user. FIG. 2 depicts a flat structure 200 in accordance with the prior art, in which site network components are listed merely by site number. That is, a parent node 202 includes a simple, one-dimensional list of sites 204. In contrast, FIG. 3 depicts a hierarchical structure (or “tree”) of nodes in which the sites are arranged geographically as described above. FIG. 4 shows a further expanded view in which individual devices and IDs (i.e., the “leaves” of the tree) are displayed. This organization may be specified using a text-based configuration file, or through any suitable user interface.

A “tree structure,” as that term is used in the art, is a set of linked nodes, where each node has zero or more “child nodes” below it in the hierarchy. A node that has a child is called the child's “parent node,” and the topmost node is the “root node.” Nodes at the bottom level, and which do not have any children, are called “leaf nodes.”

Accordingly, referring to FIG. 3, a tree structure 300 includes a root node 302 (“All Devices”), which has a number of child nodes 304—e.g., “Warehouse1,” “Bellevue, Wash,” “Factory,” “US,” etc. These child nodes are geographical in that they refer to separate physical sites. In this example, “US” node 308 includes two child nodes, 310 (“East”) and 320 (“West”), each of which includes various child nodes. “East” node 310 includes “NY” node 312, which includes a number of site nodes 314 “site1a_{—}21”-“site1a_{—}29”. Similarly, “West” node 320 includes various regional nodes 322, 324, and 326 (“CA,” “LV,” and “NV,” respectively).

FIG. 6 depicts a tree structure that has been expanded such that its leaf nodes are displayed. In this illustration, The root node 302 includes various child nodes, such as “Network Operations Center” 304, which includes progressively lower hierarchy nodes “Mobile Device” 402, “MC50” 404, and “00:0B:6C:2A:C7:F1,” which corresponds to a particular MAC address of a networked device. It will be appreciated that the text associated with the various nodes are shown for example purposes, and that the invention is not so limited.

As shown in FIG. 6, the various nodes may be displayed and organized in any manner desired by the user. For example, the sites may be viewed by “Device Type” as shown, or using any other criterion.

In one embodiment, the hierarchy of the tree is built based on pattern matching of text strings used to name the various network components, which is configurable based on user needs. That is, once the sites are organized, the console allows for easy site management by applying policies to each of the sites.

In one embodiment, for example, the default pattern is “.”—i.e., when a site name is provided as, for example, “US.West.CA”, the system creates a node called “US”, which contains a child node called “West”, which in turn contains a child node called “CA”. Similarly, if there is another site called “US.West.NV,” then the “NV” is created under the same node, “West.” The default pattern can preferably be changed to any string that the customer prefers, e.g., in accordance with Java's Regular Expression syntax.

In one embodiment, the system further allows creation of “deeper” trees in reverse order. For example, if there are two sites called “store1.symbol.com” and “store2.symbol.com”, instead of creating nodes “store1→symbol→com” and “store2→symbol→com”, the system constructs the nodes in reverse order—i.e., “com” contains child node “symbol”, which contains child nodes “store1” and “store2.”

Thus, in accordance with the present invention, hierarchical organization creates a “deeper” tree and gives the user more control. Using a suitable user interface, the user can expand and contract the tree to view just the node(s) that contain the site or sites of interest at any given time. This is done by the user through any networked computer or component that has access to MSP 103. As a result, the present invention substantially reduces the quantity and complexity of the content and dramatically improves the responsiveness of the console.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention and the legal equivalents thereof.

1. A method for visually representing components at multiple sites within a wireless local area network (WLAN), the method comprising:
providing a console coupled to the WLAN;
organizing, through the console, the components in the multiple sites in a hierarchical tree structure, wherein the tree structure includes a root node, a plurality of site nodes for which the root node is a parent node, and at least one leaf node associated with one of the root nodes, wherein the at least one leaf node corresponds to one of the components; and
displaying, via the console, hierarchical tree structure of the components.

2. The method of claim 1, wherein the step of organizing includes organizing the components based on IP address notation.

3. The method of claim 1, wherein the step of organizing includes geographically organizing the components.

4. The method of claim 1, wherein the organizing step includes organizing the components based on pattern matching of text strings associated with the components.

5. The method of claim 4, wherein the text strings include one or more delimiters used to determine the organization and names of the components in the hierarchical tree structure.

6. The method of claim 5, wherein the delimiter is a single character.

7. The method of claim 4, wherein pattern matching is performed in accordance with a Java Regular Expression syntax.

8. The method of claim 4, wherein the hierarchical tree structure is organized by specifying nodes in reverse order of appearance in the text strings.

9. The method of claim 1, wherein the leaf node corresponds to a MAC address of one of the components.

10. A system for visually representing components at multiple sites within a wireless local area network (WLAN), the system comprising:
a plurality of network components coupled to the WLAN, the network components including at least one of an access port, a wireless switch, and a mobile unit; and
a console coupled to the WLAN, the console configured to organize and display the network components in a hierarchical tree structure, wherein the tree structure includes a root node, a plurality of site nodes for which the root node is a parent node, and at least one leaf node associated with one of the root nodes, wherein the at least one leaf node corresponds to one of the network components.

11. The system of claim 10, wherein the console is configured to organize the components based on IP address notation.

12. The system of claim 10, wherein the console is configured to organize the components based on geography.

13. The system of claim 10, wherein the console is configured to organize the components based on pattern matching of text strings associated with the components.

14. The system of claim 13, wherein the text strings include one or more delimiters used to determine the organization and names of the components in the hierarchical tree structure.

15. The system of claim 14, wherein the delimiter is a single character.

16. The system of claim 13, wherein the pattern matching is performed in accordance with a Java Regular Expression syntax.

17. The system of claim 10, wherein the hierarchical tree structure is organized by specifying nodes in reverse order of appearance in the text strings.

18. A console coupled to a wireless local area network (WLAN) of the type including multiple sites, wherein each site includes at least a wireless switch, an access port, and a mobile unit associated with the access port, wherein the console is configured to accept input from a user and then organize and display a hierarchical tree structure specifying the location of the wireless switches, the access ports, and the mobile units according their respective site locations and network configuration.
